(19) United States
(12) Patent Application Publication
(10) Pub. No.: US 2009/0122463 A1
(43) Pub. Date: May 14, 2009

(54) TOP TO BOTTOM ELECTRODE CONNECTION ON SINGLE LAYER CERAMIC CAPACITORS

(75) Inventors: Huong K. Nguyen, Myrtle Beach, SC (US); Marilynn L. Young, Conway, SC (US)

Correspondence Address: DORITY & MANNING, P.A., POST OFFICE BOX 1449, GREENVILLE, SC, 29602-1449, US

(73) Assignee: AVX Corporation, Myrtle Beach, SC (US)

(21) Appl. No.: 12/265,039

(22) Filed: Nov. 5, 2008

Related U.S. Application Data
(60) Provisional application No. 60/986,628, filed on Nov. 9, 2007.

(51) Int. Cl. H01G 4/12

(52) U.S. Cl. 361/321.2; 29/25.42; 361/321.1

(57) ABSTRACT

Disclosed are methodology and corresponding device subject matters for providing single layer ceramic capacitors through the use of significantly reduced numbers of processing steps. An aspect of present methodology resides in the early introduction of a plurality of selectively spaced through holes in an unfired ceramic wafer. Such holes provide connection points between conductive coatings on both sides of a subsequently fired wafer and eliminate the need to perform a previously employed third sputtering step to achieve connection between the layers. The present methodology also provides for end of process determination of final capacitive values for the finished devices.

### PRIORITY CLAIM

This application claims the benefit of previously filed U.S. Provisional Patent Application entitled “TOP TO BOTTOM ELECTRODE CONNECTION ON SINGLE LAYER CERAMIC CAPACITORS,” assigned U.S. Ser. No. 60/986,628, filed Nov. 9, 2007, and which is incorporated herein by reference for all purposes.

### FIELD OF THE INVENTION

The present subject mater relates to capacitors. More particularly, the present subject matter relates to single layer ceramic capacitor structures having broad applicability to DC blocking and bypass technologies.

### BACKGROUND OF THE INVENTION

The present subject matter generally concerns improved component design for capacitors that generally results in devices characterized by significantly reduced manufacturing complexity.

Integrated circuits (IC's) have been implemented for some time, but many specific features of such IC's affect or impact the design criteria for electronic components and the corresponding procedures for mounting such components. With increased functionality of integrated circuit components, the design of electronic components must become increasingly more efficient. The miniaturization of electronic components is a continuing trend in the electronics industry, and it is of particular importance to design parts that are sufficiently small, yet simultaneously characterized by high operating quality. Components are desired that are small in size and that have reliable performance characteristics, yet which can also be manufactured at relatively low costs.

Component miniaturization enables higher density mounting on circuit boards or other foundations. Thus, the spacing between components is also a limiting factor in present integrated circuit designs. Since spacing is such an important design characteristic, the size and location of termination elements or means for IC components is also a significant design characteristic.

One specific electronic component that has been used in IC applications is the decoupling capacitor. Decoupling capacitors are often used to manage electrical noise problems that occur in circuit applications. As such, one of their functions is to operate as a filter. Dramatic increases in packing density of integrated circuits require advancements in decoupling capacitor technology as well as advances in manufacturing methodologies.

While various aspects and alternative features are known in the field of single layer electronic components and related methods for manufacture, no one design has emerged that generally addresses all of the issues as discussed herein.

### SUMMARY OF THE INVENTION

In view of the recognized features encountered in the prior art and addressed by the present subject matter, improved methodology for producing single layer devices has been developed.

In an exemplary configuration, single layer capacitor structure is provided that may be sized to provide a wide range of capacitance values and effective signal bypassing capabilities for signal level lines as well as decoupling of power level lines or circuit planes.

In one of their simpler forms, a present single layer ceramic capacitor structure is provided employing simplified manufacturing processes.

Another positive aspect of the present type of device is that capacitors may be produced in accordance with the present technology resulting in relatively small devices that allow for distributed placement of the devices over a circuit board while advantageously at significant cost savings.

In accordance with aspects of certain embodiments of the present subject matter, methodologies are provided to simplify connection between surfaces of a single layer device.

In accordance with certain aspects of other embodiments of the present subject matter, methodologies have been developed to provide single layer capacitors having characteristics for decoupling applications.

In accordance with yet additional aspects of further embodiments of the present subject matter, apparatus and accompanying methodology subject matter have been developed to provide single layer capacitive components configured to be optionally employed in the implementation of multi-layered capacitive components.

According to yet still other aspects of additional embodiments of the present subject matter, apparatus and corresponding and/or accompanying methodology subject matters have been developed to provide devices with capacitance values that may be selected as a part of the final portions of the manufacturing process.

More generally, it is to be understood that various aspects of embodiments of the present subject matter relate to apparatuses while other aspects thereof equally relate to either or both of accompanying or corresponding methodologies.

One exemplary present embodiment relates to methodology for producing single layer electronic devices, comprising the steps of fabricating a green ceramic wafer having designated respective top and bottom sides; forming vias in selected portions of the green ceramic wafer; firing the green ceramic wafer so as to create a fired ceramic wafer; coating the top and bottom sides of the fired ceramic wafer with conductive material, such that the conductive material is received in the vias and interconnects from the respective top and bottom sides of the fired ceramic wafer so as to create a conductively coated fired ceramic wafer; cutting the conductively coated fired ceramic wafer into strips; forming conductively cleared areas on the top sides of the strips, so as to form respective, separate conductive regions on the top sides of each of the respective strips; and singulating the respective strips into individual single layer electronic devices.

In certain of the foregoing embodiments, such forming may comprise mechanical drilling, laser ablation, or die punching. Such coating in some embodiments may comprise sputter coating the conductive material in successive substeps, one for each side of the fired ceramic wafer, while in other embodiments such singulating may include selectively dicing the respective strips into individual single layer electronic devices comprising capacitor devices, each having at least one of the vias so as to have respective top to bottom electrode connections for each such capacitor device. Still further, in some embodiments, selectively dicing the respective strips into singulated capacitor devices may include selectively controlling such dicing so as to establish desired capacitance values of the respective resulting capacitor devices.

In yet another alternative present exemplary embodiment, an exemplary present methodology for producing single layer capacitor devices having respective top to bottom electrode connections, may consist of the steps of fabricating a green ceramic wafer having designated respective top and bottom sides; drilling a plurality of vias in a plurality of respective selected portions of the green ceramic wafer; firing the green ceramic wafer so as to create a fired ceramic wafer; sputter coating the top and bottom sides of the fired ceramic wafer with conductive material, such that the conductive material is received in the vias and interconnects through the vias and between the respective top and bottom sides of the fired ceramic wafer so as to create a coated fired ceramic wafer; dicing the coated fired ceramic wafer into strips; skim-cutting conductively cleared margins on the top sides of the respective strips, so as to form respective, separate conductive regions on the top sides of each of the respective strips; and selectively dicing the respective strips into individual single layer capacitor devices, each having at least one of the vias so as to have respective top to bottom electrode connections for each such capacitor device.

A still further exemplary present embodiment may relate to a method for manufacturing capacitor devices having adjusted capacitor values, comprising the steps of drilling with one of mechanical drilling, laser ablation, and die punching, a plurality of vias in a plurality of respective selected portions of a green ceramic wafer having respective top and bottom sides; firing the drilled green ceramic wafer so as to create a fired ceramic wafer; sputter coating the top and bottom sides and the drilled vias of the fired ceramic wafer with conductive material, such that the conductive material is received in the vias and interconnects from the respective top and bottom sides of the fired ceramic wafer so as to create a conductively coated fired ceramic wafer having conductive top and bottom sides thereof conductively connected by such plurality of sputtered vias; dicing the coated fired ceramic wafer into strips; skim-cutting conductively cleared margins on the top sides of the respective strips, so as to form respective, separate conductive regions on the top sides of each of the respective strips; and selectively dicing the respective strips into singulated capacitor devices, with such dicing selectively controlled so as to establish desired capacitance values of the respective resulting capacitor devices.

In certain of the foregoing exemplary embodiments, a plurality of such singulated capacitor devices may be stacked so as to form multilayer capacitor devices. Further, optionally, the width between dicing lines between respective strips may be adjusted for controlling the final values of the respective resulting capacitor devices.

In other of the foregoing exemplary embodiments, laser ablation may be performed so as to remove additional selected portions of conductive material adjacent the skim-cut margins, so as to even more precisely adjust the respective areas of the respective, separate conductive regions on the top sides of each of the respective strips, for determining desired capacitance values.

In further of the foregoing exemplary embodiments, desired capacitance values of such respective resulting capacitor devices may be selected for use in one of DC blocking and bypass capacitor configurations, while at other times they may be selected for use in decoupling capacitor configurations for decoupling of power level lines or circuit planes.

In other present exemplary embodiments, the present respective resulting capacitor devices may be operatively associated with one of a printed circuit board and an electronic device. In certain of those instances, such operatively associating may include soldering the respective resulting capacitor devices to one of conductive traces, other conductive components, and conductive connections.

Stiff further present exemplary embodiments may relate to presently disclosed devices. One exemplary such embodiment relates to a single layer capacitor device, comprising a ceramic layer having designated respective top and bottom sides, and at least one circumferential lateral side edge; first conductive material coating at least first and second respective regions of such designated top side of such ceramic layer; second conductive material coating at least such designated bottom side of such ceramic layer; and a conductive via formed through such ceramic layer and conductively connecting such first and second conductive materials on such respective designated top and bottom sides of such ceramic layer without requiring conductive material around a lateral side edge of such ceramic layer. In such exemplary embodiment, the final capacitance value of such capacitor device may be determined in part by a preselected separation distance between such first and second respective regions of such designated top side of such ceramic layer. In certain present such embodiments, such capacitor device may comprise a decoupling capacitor. In other present alternative instances, a plurality of such capacitor devices may be respectively stacked and operatively interconnected so as to form a multilayer capacitor device.

Additional objects and advantages of the present subject matter are set forth in, or will be apparent to, those of ordinary skill in the art from the detailed description herein. Also, it should be further appreciated that modifications and variations to the specifically illustrated, referred, and discussed features, elements, and steps hereof may be practiced in various embodiments and uses of the present subject matter without departing from the spirit and scope of the present subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the present subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the present subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIGS. 1a and 1b, respectively, illustrate perspective and cross-sectional views of a previously known single layer capacitor;

FIGS. 2a and 2b, respectively, illustrate perspective and cross-sectional views of an exemplary single layer capacitor constructed in accordance with the presently disclosed technology;

FIG. 3 is a flow chart illustrating manufacturing steps required for construction of a known single layer capacitor;

FIGS. 4a through 4g, respectively, depict construction aspects of a known single layer capacitor;

FIG. 5 is a flow chart illustrating manufacturing steps for construction of a present exemplary single layer capacitor in accordance with presently disclosed technology; and

FIGS. 6a through 6e, respectively, depict construction aspects of an exemplary embodiment of a single layer capacitor constructed in accordance with the presently disclosed technology.

Repeat use of reference characters throughout the present specification and appended drawings is intended to represent same or analogous features, elements, or steps of the present subject matter.

### DETAILED DESCRIPTION OF THE PREFERRED EMBODIMENTS

As discussed in the Summary of the Invention section, the present subject matter is particularly concerned with improved methodology for producing single layer devices.

Selected combinations of aspects of the disclosed technology correspond to a plurality of different embodiments of the present subject matter. It should be noted that each of the exemplary embodiments presented and discussed herein should not insinuate limitations of the present subject matter. Features or steps illustrated or described as part of one embodiment may be used in combination with aspects of another embodiment to yield yet further embodiments. Additionally, certain features may be interchanged with similar devices or features not expressly mentioned but which perform the same or similar function.

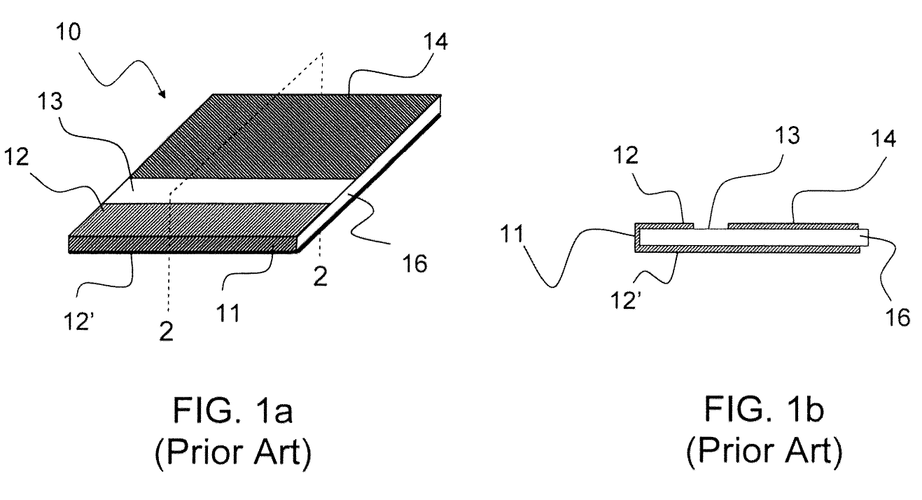

Reference will now be made in detail to the presently preferred embodiments of the subject single layer capacitor construction methodology. Referring now to the drawings, FIGS. 1a and 1b, respectively, represent perspective and cross-sectional views of a previously known single layer capacitor.

As may be seen in FIG. 1a, there is illustrated a single layer capacitor 10 constructed in accordance with previously known technology. Previously known capacitor 10 is provided with terminations 12, 14 covering portions of the top surface of ceramic layer 16. Terminations 12, 14 may be used to mount capacitor 10 to a printed circuit board or to operatively associate capacitor 10 with an electronic device by way of appropriate techniques, including, for example, soldering, to conductive traces or other conductive components or connections. Conductive layer 12′ covers the bottom portion of ceramic layer 16 and is electrically connected to electrical layer 12 by way of electrical layer 11.

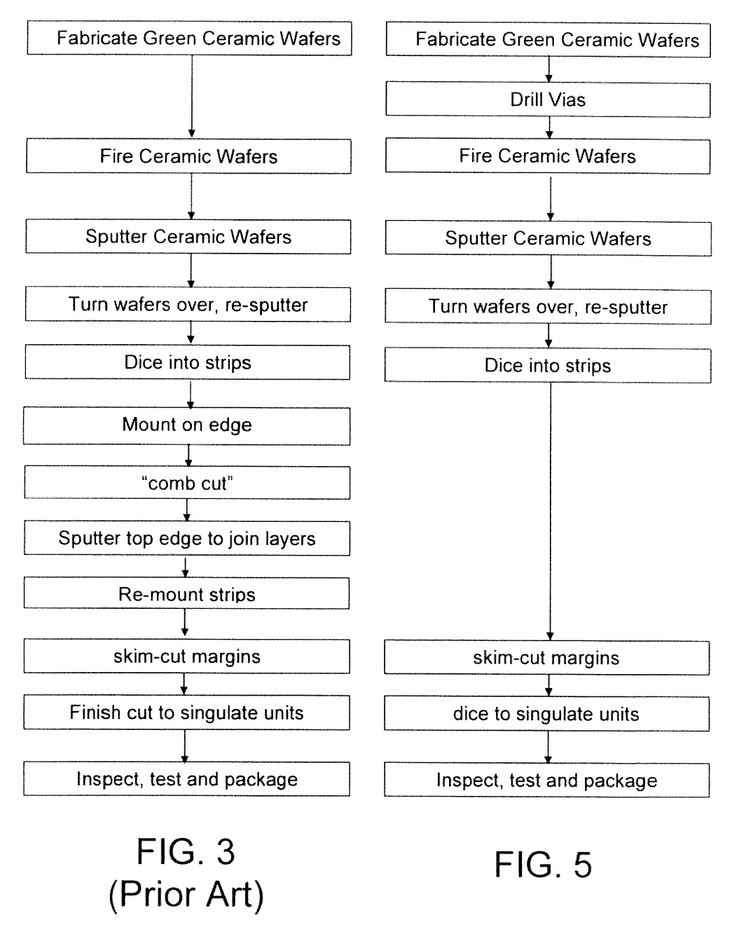

Top surface layers 12 and 14 may have been applied as a single layer and then separated by skim-cut 13, as will be described more fully with reference to FIG. 3.

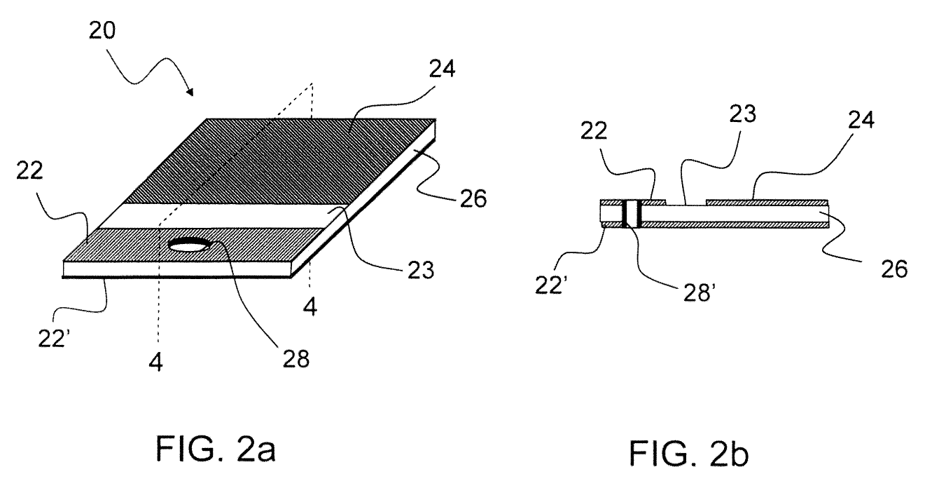

With reference now to FIGS. 2a and 2b, there is illustrated an exemplary single layer capacitor 20 constructed in accordance with present technology. As may be seen by comparison of FIGS. 1a and 1b with FIGS. 2a and 2b, respectively, capacitors 10 and 20 each contain a number of functionally similar components. Capacitor 20 is provided with terminations 22, 24 covering portions of the top surface of ceramic layer 26. Conductive layer 22′ covers the bottom portion of ceramic layer 26.

In accordance with present technology, top surface layers 22 and 24 may have been applied as a single layer and then separated by skim-cut 23, as will be described more fully with reference to FIG. 5.

While the respective top and bottom conductive layers 12, 12′ in capacitor 10 are electrically connected by conductive layer 11, the present technology importantly provides a functionally replacing connection by way of via 28′. As will be further explained with reference to FIGS. 3 and 5, use of via 28′ in place of conductive layer 11 significantly simplifies construction of present capacitor 20, and provides additional advantages, including, for example, the ability to vary the final capacitive value of present capacitor 20 simply by varying the final width of the component.

With reference now to FIGS. 3 and 5, a direct comparison may be made with respect to construction methodologies between previously known capacitor 10 and an exemplary capacitor 20 in accordance with present technology. As may be seen respectively in such FIGS. 3 and 5, construction of both capacitors 10 and 20 begins with fabrication of a green ceramic wafer. However, in the case of the present technology, there are immediate differences in that vias are drilled in selected portions of the green ceramic wafer. Any suitable drilling methodology may be employed including, but not limited to, laser ablation, mechanical drilling, and die punching, all of which (and any equivalents thereof) are encompassed within the broader aspects of the present subject matter.

In both the known methodology and the methodology in accordance with present technology, the green ceramic wafers are then fired, sputtered coated on one side with suitable conductive material, turned over, re-sputtered, and then diced into strips. However, in accordance with present technology, after such steps, the sputtered conductive layers are electrically connected together by way of via 28′ due to coating material sputtering into hole 28 (see present FIGS. 2a, 2b) and coating the sides of hole 28 along with the top and bottom surfaces of the fired ceramic wafer.

Following the common step of dicing into strips, construction of previously known capacitor 10 still requires a number of additional steps in order to electrically couple together the top and bottom conductive layers on the ceramic wafer, whereas, in accordance with the present technology and due to the previous step of providing holes in selected portions of the ceramic wafer, such electrical connection has already been achieved by way of the pair of sputtering steps.

With reference to FIG. 3, it will be seen that additional steps, including mounting the diced strips, providing multiple partial (comb) cuts through the mounted strips, an additional sputtering step, and remounting of the strips, are required to provide a structure electrically equivalent to that of the thus far constructed present subject matter.

With reference again to FIGS. 3 and 5, it will be seen that in both the previously known construction and that of the present technology, the final construction steps are similar in both cases and include skim-cutting margins 13 (FIGS. 1a and 1b) and 23 (FIGS. 2a and 2b) in the respective exemplary devices to separate the top surface conductive layer to respectively produce separate conductive regions 12, 14 (FIG. 1a) and 22, 24 (FIG. 2a).

Following skim-cutting, the previously known device is singulated, i.e., separated into individual pieces, by finishing the cut started during the comb cut. Since singulation is achieved by completing a previously begun cut, the final capacitance value for the finished capacitor is largely determined at an early stage of the capacitor construction.

In comparison, exemplary capacitor 20, constructed in accordance with the present technology, is produced with a capacitance value that is determined just prior to final testing and packaging of the finished device. More specifically, the diced and skim-cut devices are diced again (FIG. 5) to singulate the individual devices. Such dicing gives the manufacturer the opportunity to adjust the width between dicing lines, thus controlling the final value of the capacitor component. Such a possibility or option is not readily available with the previously known construction methodology.

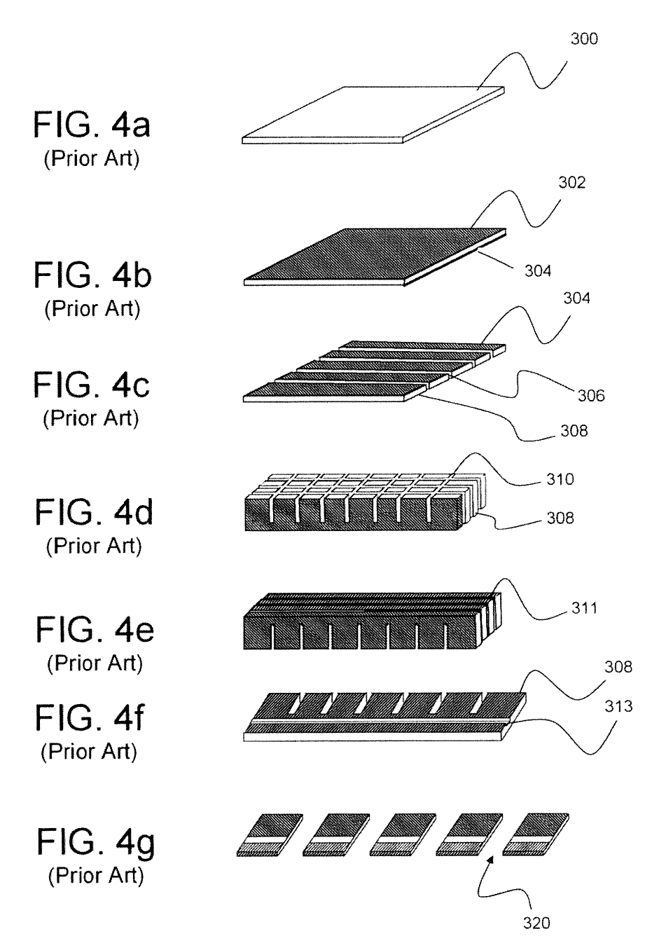

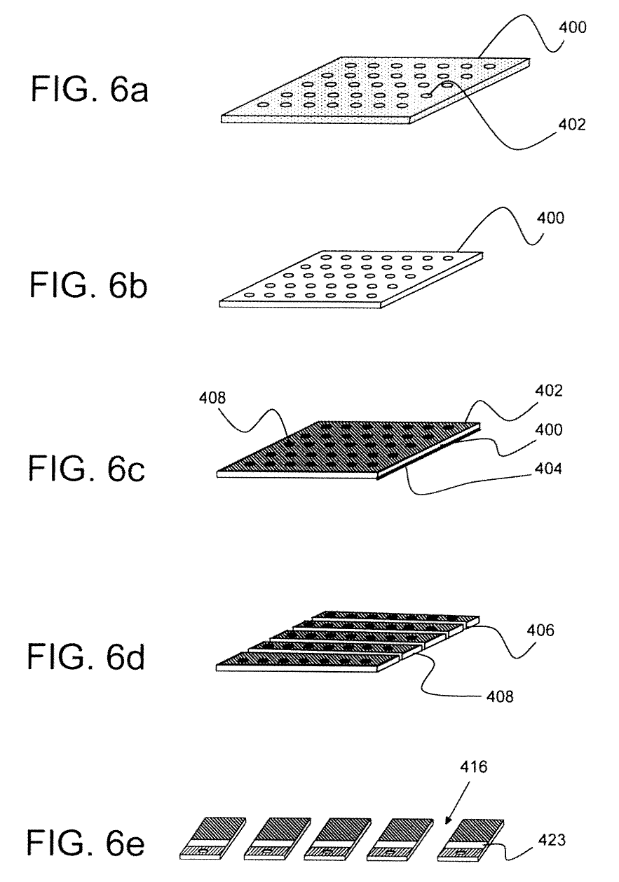

With respective reference now to FIGS. 4a through 4g and 6a through 6e, comparisons can more easily be seen between steps in the construction of the previously known capacitor 10 versus that of the present technology resulting in present exemplary capacitor 20.

As may be seen in FIG. 4a, construction of the previously known capacitor 10 begins with a green ceramic layer 300 that is then fired. After firing, and as illustrated in FIG. 4b, a metallic coating 302 is sputtered onto a first side of wafer 300. Continuing with the previously known construction methodology, the piece is then flipped over so that a second conductive layer 304 may be sputtered onto the reverse side, after which the piece is diced along lines 306 to separate the original wafer 300 (now coated on both sides with conductive material) into a number of respective strips 308.

As illustrated in FIG. 4d, a number of the strips 308 are stood on edge and cut partially through, as illustrated with exemplary cut 310. Following such cutting, the strips are remounted with the uncut sides exposed (FIG. 4e), and a third conductive layer 311 is sputtered onto the exposed sides. Such sputtering continues until conductive coatings 302, 304 previously sputtered on the first and second surfaces of wafer 300 are electrically connected together. Following such third sputter coating process, individual strips 308 are skim-cut along line 313 to separate the previously sputtered conductive layer into two portions.

Finally, as seen in FIG. 4g, the individual devices are separated from strip 308 by completing the cut along previous cut line 310 so as to completely separate the pieces as at 320. At such point in the known process, the resulting individual pieces then correspond to that initially illustrated in FIG. 1a. Such pieces may then be inspected and packaged as required by individual customers.

With respective reference now to FIGS. 6a through 6e, processing steps in accordance with present technology may be more readily seen.

As seen in FIG. 6a, the present construction methodology begins as holes 402 are drilled at a plurality of selected locations in green ceramic wafer 400. As previously mentioned, such drilling may be accomplished in any one of a number of ways including, but not limited to, mechanical drilling, punching, and laser ablation. Drilled (or prepared) wafer 400 is then fired (FIG. 6b) per present subject matter, and conductive coatings 402, 404 are sputtered onto respective top and bottom surfaces of wafer 400 (FIG. 6c). Sputter coating of the fired wafer may be carried out by first sputter coating one side, and then flipping the piece over and sputter coating the other side. Equivalent alternatives may be practiced, for example, if desired to avoid a literal “flipping” operation.

An important aspect of the present technology is achieved during such pair of sputtering steps in that the individually drilled holes 402 are now also coated with conductive material such that the conductive surfaces 402, 404 are now electrically connected. Following such pair of sputtering steps in accordance with present subject matter, individual strips 408 are created by cutting wafer 400 along a plurality of lines 406 (FIG. 6d). Such individual strips 408 are skim-cut along line 423 (FIG. 6e) and separated into individual pieces from strip 408 by way of individual cuts along plural lines 416. The individual pieces resulting from the present subject matter then correspond to that initially illustrated in FIG. 2a. Such pieces may then be inspected and packaged as required by individual customers.

As previously observed, even at later stages of construction, due to advantages obtained with the presently disclosed subject matter, opportunities exist for providing a plurality of capacitive values from the devices presently produced simply by adjusting the spacing between cut lines 416.

Additionally, per the present subject matter, individual pieces may be further “fine tuned” to selected capacitive values by laser ablation of additional portions of the material removed along skim-cut lines 423.

Finally, it should be appreciated by those of ordinary skill in the art that the single layer capacitors produced by the present methodology may be optionally employed to produce other capacitor types including multi-layer devices by simply stacking plural single layer devices.

While the present subject matter has been described in detail with respect to specific embodiments thereof, it will be appreciated that those skilled in the art, upon attaining an understanding of the foregoing may readily produce alterations to, variations of, and/or equivalents to such embodiments. Accordingly, the scope of the present disclosure and claims is by way of example rather than by way of limitation, and the subject disclosure and claims do not preclude inclusion of such modifications, variations and/or additions to the present subject matter as would be readily apparent to one of ordinary skill in the art.

What is claimed is:

1. Methodology for producing single layer electronic devices, comprising the steps of:
fabricating a green ceramic wafer having designated respective top and bottom sides;
forming vias in selected portions of the green ceramic wafer;
firing the green ceramic wafer so as to create a fired ceramic wafer;
coating the top and bottom sides of the fired ceramic wafer with conductive material, such that the conductive material is received in the vias and interconnects from the respective top and bottom sides of the fired ceramic wafer so as to create a conductively coated fired ceramic wafer;
cutting the conductively coated fired ceramic wafer into strips;
forming conductively cleared areas on the top sides of the strips, so as to form respective, separate conductive regions on the top sides of each of the respective strips; and
singulating the respective strips into individual single layer electronic devices.

2. Methodology as in claim 1, wherein the step of forming comprises one of mechanical drilling, laser ablation, and die punching.

3. Methodology as in claim 1, wherein the step of coating comprises sputter coating the conductive material in successive substeps, one for each side of the fired ceramic wafer.

4. Methodology as in claim 1, wherein the step of singulating includes selectively dicing the respective strips into individual single layer electronic devices comprising capacitor devices, each having at least one of the vias so as to have respective top to bottom electrode connections for each such capacitor device.

5. Methodology as in claim 4, wherein the step of selectively dicing the respective strips into singulated capacitor devices includes selectively controlling such dicing so as to establish desired capacitance values of the respective resulting capacitor devices.

6. Methodology for producing single layer capacitor devices having respective top to bottom electrode connections, consisting of the steps of:
fabricating a green ceramic wafer having designated respective top and bottom sides;
drilling a plurality of vias in a plurality of respective selected portions of the green ceramic wafer;
firing the green ceramic wafer so as to create a fired ceramic wafer;
sputter coating the top and bottom sides of the fired ceramic wafer with conductive material, such that the conductive material is received in the vias and interconnects through the vias and between the respective top and bottom sides of the fired ceramic wafer so as to create a coated fired ceramic wafer;
dicing the coated fired ceramic wafer into strips;
skim-cutting conductively cleared margins on the top sides of the respective strips, so as to form respective, separate conductive regions on the top sides of each of the respective strips; and
selectively dicing the respective strips into individual single layer capacitor devices, each having at least one of the vias so as to have respective top to bottom electrode connections for each such capacitor device.

7. Methodology as in claim 6, wherein the step of drilling comprises one of mechanical drilling, laser ablation, and die punching.

8. Methodology as in claim 6, wherein the step of sputter coating comprises sputter coating the conductive material in successive substeps, one for each side of the fired ceramic wafer.

9. Methodology as in claim 8, wherein the substeps of sputter coating the fired ceramic wafer includes first sputter coating one of the top and bottom sides of the fired ceramic wafer, flipping over the wafer, and thereafter sputter coating the other of the top and bottom sides of the wafer, including the plurality of vias drilled therein.

10. Methodology as in claim 6, wherein the step of selectively dicing the respective strips into capacitor devices includes selectively controlling such dicing so as to establish desired capacitance values of the respective resulting capacitor devices.

11. Methodology as in claim 10, wherein the step of selectively controlling the dicing includes adjusting the width between dicing lines, thus controlling the final values of the respective resulting capacitor devices.

12. A method for manufacturing capacitor devices having adjusted capacitor values, comprising the steps of:
drilling with one of mechanical drilling, laser ablation, and die punching, a plurality of vias in a plurality of respective selected portions of a green ceramic wafer having respective top and bottom sides;
firing the drilled green ceramic wafer so as to create a fired ceramic wafer;
sputter coating the top and bottom sides and the drilled vias of the fired ceramic wafer with conductive material, such that the conductive material is received in the vias and interconnects from the respective top and bottom sides of the fired ceramic wafer so as to create a conductively coated fired ceramic wafer having conductive top and bottom sides thereof conductively connected by said plurality of sputtered vias;
dicing the coated fired ceramic wafer into strips;
skim-cutting conductively cleared margins on the top sides of the respective strips, so as to form respective, separate conductive regions on the top sides of each of the respective strips; and
selectively dicing the respective strips into singulated capacitor devices, with such dicing selectively controlled so as to establish desired capacitance values of the respective resulting capacitor devices.

13. A method as in claim 12, further comprising the step of stacking a plurality of the singulated capacitor devices so as to form multilayer capacitor devices.

14. A method as in claim 12, wherein the step of selectively dicing the respective strips includes adjusting the width between dicing lines, thus controlling the final values of the respective resulting capacitor devices.

15. A method as in claim 12, wherein the step of sputter coating the fired ceramic wafer includes first sputter coating one of the top and bottom sides of the fired ceramic wafer, flipping over the wafer, and thereafter sputter coating the other of the top and bottom sides of the wafer, including the plurality of vias drilled therein.

16. A method as in claim 12, further including the step of additionally forming with relatively greater precision the desired capacitance values by performing laser ablation so as to remove additional selected portions of conductive material adjacent the skim-cut margins, so as to adjust the respective areas of the respective, separate conductive regions on the top sides of each of the respective strips.

17. A method as in claim 16, wherein the desired capacitance values of such respective resulting capacitor devices are selected for use in one of DC blocking and bypass capacitor configurations.

18. A method as in claim 16, wherein the desired capacitance values of such respective resulting capacitor devices are selected for use in decoupling capacitor configurations for decoupling of power level lines or circuit planes.

19. A method as in claim 12, further including operatively associating the respective resulting capacitor devices with one of a printed circuit board and an electronic device.

20. A method as in claim 19, wherein the step of operatively associating includes soldering the respective resulting capacitor devices to one of conductive traces, other conductive components, and conductive connections.

21. A method as in claim 12, further including the step of additionally forming with relatively greater precision the desired capacitance values by selectively varying the final width of the respective areas of the respective, separate conductive regions on the top sides of each of the respective strips.

22. A single layer capacitor device, comprising:
a ceramic layer having designated respective top and bottom sides, and at least one circumferential lateral side edge;
first conductive material coating at least first and second respective regions of said designated top side of said ceramic layer;
second conductive material coating at least said designated bottom side of said ceramic layer;
and a conductive via formed through said ceramic layer and conductively connecting said first and second conductive materials on said respective designated top and bottom sides of said ceramic layer without requiring conductive material around a lateral side edge of said ceramic layer.

23. A single layer capacitor device as in claim 22, wherein the final capacitance value of said capacitor device is determined in part by a preselected separation distance between said first and second respective regions of said designated top side of said ceramic layer.

24. A single layer capacitor device as in claim 23, wherein said capacitor device comprises a decoupling capacitor.

25. A single layer capacitor device as in claim 22, further comprising a plurality of said capacitor devices respectively stacked and operatively interconnected so as to form a multilayer capacitor device.
